(19) United States
(12) Patent Application Publication
(10) Pub. No.: US 2026/0220916 A1
(43) Pub. Date: Jul. 30, 2026

(54) SYSTEM AND METHOD FOR MEDIA LIBRARY CHARACTERIZATION

(71) Applicant: Jonathan SHEM UR, TEL-AVIV (IL)

(72) Inventor: Jonathan SHEM UR, TEL-AVIV (IL)

(21) Appl. No.: 19/459,258

(22) Filed: Jan. 26, 2026

Related U.S. Application Data
(60) Provisional application No. 63/749,608, filed on Jan. 26, 2025.

(51) Int. Cl. G06V 10/764; G06F 16/3329; G06Q 10/40; G06Q 30/0601; G06V 30/10

(52) U.S. Cl. CPC G06V 10/764; G06F 16/33295; G06Q 10/40; G06Q 30/0601; G06V 30/10

(57) ABSTRACT

Systems and methods for generating characterization vectors representing physical media libraries may involve a client device for capturing image data and a server system for performing analysis and vector generation including obtaining image data of a library, identifying media items from the image data, and extracting an item dataset comprising item-level metrics. The item dataset is analyzed to determine library-level metrics, which are derived from collective attributes of the media items independent of behavioral data indicating user consumption. A multi-dimensional characterization vector is generated from the library-level metrics, which may be used to provide personalized content recommendations based on structural alignment with a user's library and to determine compatibility score between different users to facilitate social connections.

### CROSS-REFERENCE TO RELATED APPLICATIONS

This application claims priority and benefit from U.S. Provisional Patent Application No. 63/749,608, filed Jan. 26, 2025, the contents and disclosure of which are incorporated herein by reference in their entirety.

### FIELD

The disclosure herein relates to systems and methods for digitizing and analyzing collections of physical items. In particular, the disclosure relates to systems and methods for generating a characterization vector for a physical media library based on image data and using the vector for recommendations and compatibility analysis.

### BACKGROUND

Many individuals possess extensive personal collections of physical media, such as libraries of books, records, videos etc. as well as collections of cooking utensils, tools, scientific equipment or the like. These physical collections often represent a significant personal investment and reflect the owner's intellectual journey, interests, and personality. The tangible nature of a physical book, with its unique cover, feel, and even smell, creates a user experience that digital e-books cannot fully replicate. Consequently, physical media libraries remain highly valued.

However, these physical collections suffer from a significant drawback in the digital age: a lack of searchability and analysis. Unlike a digital library, a physical library cannot be easily searched to find a specific item. A user may know they own a particular book but be unable to locate it among hundreds or thousands of others on their shelves. This problem is exacerbated in larger personal libraries, which are typically not catalogued with the rigor of a public institution.

Furthermore, existing solutions do not provide a way to understand the intrinsic character of a physical collection as a whole. While an owner may have a general sense of their tastes, there is no automated method to analyze the structural properties of their library—such as the recurrence of certain authors, the distribution of genres, or the evolution of their collection over time. This untapped data represents a rich source of information about the user's unique intellectual profile, which cannot be leveraged by conventional recommendation or social matching systems that rely solely on active user behavior like clicks, ratings, or purchase history.

The need remains, therefore, for a system and method that not only facilitates the efficient location and retrieval of items from a physical library but also analyzes the structural composition of the library to generate a unique characterization profile for recommendations and social discovery. The invention described herein addresses the above-described needs.

### SUMMARY

The present disclosure provides systems and methods for creating a digital representation of a physical media library and generating a unique characterization profile based on its contents. In some aspects, the system may capture image data of a physical library, such as bookshelves, using a client device like a smartphone or an autonomous drone. A server system may then process this image data to identify individual media items and extract a dataset of their attributes.

Unlike conventional systems that track user behavior, aspects of the present disclosure may analyze the intrinsic, collective properties of the library's contents, independent of user consumption data. This analysis may result in the generation of a multi-dimensional characterization vector that serves as a unique signature of the library. This vector may then be used for a variety of novel applications, including generating personalized content recommendations based on structural alignment with the user's existing collection, or determining a compatibility score between different users to facilitate social connections between like-minded individuals.

In some aspects, a computer-implemented method for generating a characterization vector representing a physical media library is provided. The method may comprise obtaining image data of the physical media library; identifying a plurality of media items from the image data; extracting an item dataset from the image data, the item dataset comprising a plurality of item-level metrics pertaining to each identified media item; analyzing the item dataset to determine a plurality of library-level metrics, wherein the library-level metrics are derived from collective attributes of the media items and are independent of behavioral data indicating user consumption of said items; and generating the characterization vector as a multi-dimensional data structure populated with values derived from the determined plurality of library-level metrics.

The step of obtaining the image data may comprise capturing one or more images of bookshelves within the physical media library using a camera of a mobile computing device. Alternatively, obtaining the image data may comprise capturing one or more images of bookshelves within the physical media library using a camera mounted on an indoor unmanned aerial vehicle (UAV). The method may further comprise autonomously navigating the UAV to perform the capturing of the one or more images periodically, or in response to a user command.

The step of identifying the plurality of media items may comprise performing optical character recognition (OCR) on text displayed on the spines of the media items in the image data. The step of extracting the item dataset may further comprise augmenting data identified from the image data by querying one or more external databases to retrieve supplementary information. The item-level metrics may be selected from a group consisting of: a title, an author, a publisher, a year of publication, an edition, a language, a thematic category, a physical location within the library, an assessed physical condition, and combinations thereof. The assessed physical condition may comprise an indication of usage based on a visible amount of dust or an indication of deterioration based on apparent age.

The step of analyzing the item dataset may comprise performing at least one of: calculating a frequency of occurrence of a shared attribute among the plurality of media items; analyzing a temporal distribution associated with the plurality of media items; or assessing a relative popularity of one or more of the media items by comparison to an external reference corpus. The library-level metrics may be selected from a group consisting of: a recurrence rate for one or more authors, a recurrence rate for one or more thematic categories, a temporal distribution of item acquisition dates, a temporal distribution of item publication dates, a diversity of languages, a ratio of fiction to non-fiction, a relative popularity score, and combinations thereof.

The method may further comprise assigning a reliability weight to each media item in the item dataset, wherein the analysis is performed on a weighted item dataset. Assigning the reliability weight may comprise reducing the influence of media items classified as having high popularity relative to an external reference corpus. The method may also comprise partitioning the item dataset into two or more temporal acquisition clusters and performing the analyzing and generating steps for each cluster to generate a separate characterization vector for each acquisition period. The method may further comprise computing a plurality of similarity scores by comparing the generated characterization vector to a plurality of content vectors associated with candidate media items, and outputting a ranked list of recommended candidate media items. The similarity scores may reflect a structural alignment between the characterization vector and the content vectors.

In other aspects, a system for generating a characterization vector is provided. The system may comprise a client device and a server system. The client device may comprise an image capture device and a communication interface and may be configured to capture and transmit image data. The server system may be communicatively coupled to the client device and may comprise processors and a database. The processors may be configured to execute instructions for a plurality of modules, comprising an Image Processing Module, a Data Extraction Module, a Library Analysis Module, and a Vector Generation Module. The client device may be a mobile computing device or an indoor UAV. The server system may be configured to compute a flight path for the UAV. The Image Processing Module may be further configured to construct a unified spatial model of the library by computationally stitching image frames. The system may further comprise a Recommendation Module, a Compatibility Analysis Module, a Retrieval Guidance Module, and a Community Platform Module.

In further aspects, a computer-implemented method for determining a compatibility score between entities is provided. The method may comprise obtaining a first characterization vector for a first entity and a second characterization vector for a second entity, wherein the vectors represent library-level metrics derived from collective attributes of items and are independent of user consumption data. The method may further comprise computing the compatibility score based on a comparative structural alignment between the vectors and outputting a compatibility result. The entities may be users, group profiles, or curated collections. The method may further comprise clustering users into groups based on compatibility scores. The physical media library may be a collection of items such as books, records, science equipment, kitchen equipment, tools, or the like.

In yet other aspects, a system for determining a compatibility score is provided. The system may comprise a server system having a database storing a plurality of characterization vectors and a client device with a display. The server may comprise a Compatibility Analysis Module configured to retrieve two characterization vectors, compute the compatibility score based on comparative structural alignment, and generate a result. The server may then transmit the result to the client device for presentation. The system may further comprise a Social Networking Module to suggest connections based on the score.

### BRIEF DESCRIPTION OF THE DRAWINGS

For a better understanding of the embodiments and to show how it may be carried into effect, reference will now be made, purely by way of example, to the accompanying drawing figures. With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 is a block diagram illustrating a system architecture for generating a characterization vector;

FIGS. 2A and 2B are schematic views illustrating exemplary methods for obtaining image data of a physical media library;

FIG. 3 is a flowchart illustrating a method for generating a characterization vector;

FIG. 4 is a data transformation process diagram illustrating the generation of a characterization vector from raw image data;

FIG. 5 is a flowchart illustrating a method for determining a compatibility score between two entities;

FIG. 6 is a conceptual diagram illustrating a content recommendation process;

FIG. 7 is a conceptual diagram illustrating social features based on compatibility analysis; and

FIG. 8 is a diagram illustrating an exemplary user interface for a media item retrieval application.

### DETAILED DESCRIPTION

Aspects of the present disclosure relate to systems and methods for creating a digital profile of a physical media library based on image analysis. This digital profile, or characterization vector, may be used to enable advanced features such as item retrieval, content recommendation, and social compatibility matching.

In some aspects, a user may capture images of their physical library, such as a collection of books, using a client device. The images may be transmitted to a server system where they are processed to identify the individual items and their attributes. The server may analyze the collective properties of the library's contents to generate a multi-dimensional characterization vector, which serves as a unique signature of the library. This vector, which is based on the inherent structure of the collection rather than on user behavior, may then be compared to other vectors to provide personalized recommendations for new content or to identify other users with similar tastes and interests.

As required, detailed embodiments of the present disclosure are disclosed herein; however, it is to be understood that the disclosed embodiments are merely exemplary of the aspects that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure.

As appropriate, in various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard disk, flash-drive, removable media or the like, for storing instructions and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

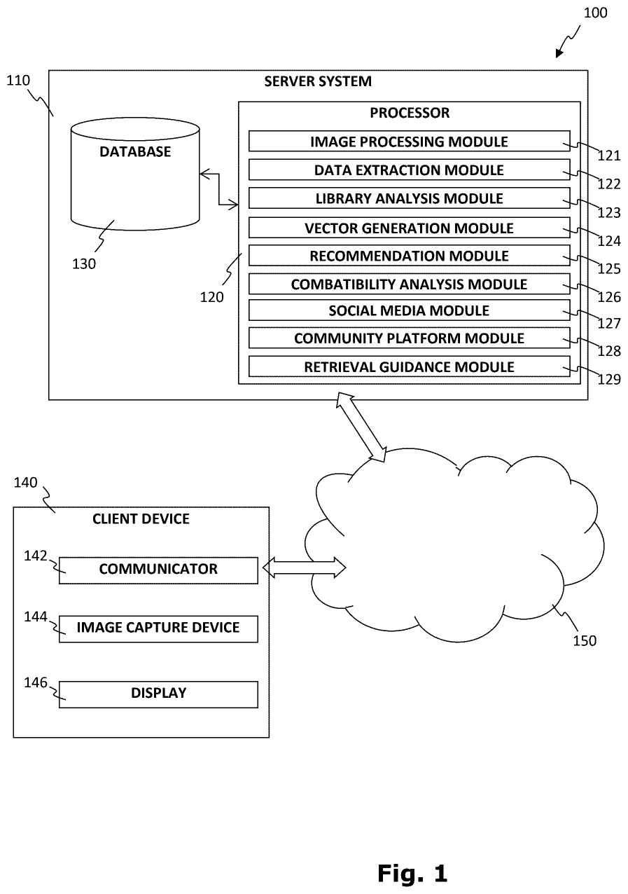

Reference is now made to FIG. 1, which shows a system architecture block diagram 100 in accordance with aspects of the present disclosure. The system 100 shows a server system 110, a client device 140, and a communication network 150 that communicatively couples the server system 110 and the client device 140.

The server system 110 may be configured as one or more physical or virtual servers, and may be implemented within a cloud computing environment, a distributed computing architecture, or the like. The server system 110 may comprise one or more processors 120 and at least one database 130. The processor(s) 120 may be configured to execute instructions stored in memory to implement a plurality of functional software modules. These modules may comprise, without limitation, an Image Processing Module 121, a Data Extraction Module 122, a Library Analysis Module 123, a Vector Generation Module 124, a Recommendation Module 125, a Compatibility Analysis Module 126, a Social Media Module 127, a Community Platform Module 128, and a Retrieval Guidance Module 129.

The Image Processing Module 121 may be configured to receive image data from the client device 140. It may process this image data to identify a plurality of media items. In some aspects, this module may be configured to perform advanced processing by computationally stitching multiple, potentially overlapping image frames, which may have been captured under variably lit conditions or from different angles, to construct a unified spatial model of a library. This stitching process may include algorithms for perspective correction to create a geometrically accurate composite view. The identification of media items may be performed by applying an Optical Character Recognition (OCR) process to recognize text on the spines of items within the unified spatial model or individual images. The module may further be configured to normalize the extracted OCR text to account for variations in font, orientation, and physical wear, thereby improving the accuracy of text extraction from real-world, non-uniform items. Furthermore, the Image Processing Module 121 may perform a pixel-level analysis of the image data to determine an assessed physical condition of an item, such as its level of dustiness or physical wear.

The Data Extraction Module 122 may be configured to extract an item dataset from the processed image data. This dataset may comprise a plurality of item-level metrics for each identified media item. The module may be further configured to augment the data identified from the images by querying one or more external databases or sources to retrieve supplementary information, such as publisher details, publication year, genre classifications, and combinations thereof.

The Library Analysis Module 123 may be configured to analyze the item dataset to determine a plurality of library-level metrics. These metrics may be derived from the collective or structural properties of the media items within the library and may be independent of behavioral data indicating user consumption. Such library-level metrics may comprise, for example, a recurrence rate for authors or thematic categories, a temporal distribution of publication or acquisition dates, a diversity of languages, and a relative popularity score when compared to a reference corpus.

The Vector Generation Module 124 may be configured to generate a characterization vector, which may be a multi-dimensional data structure. This vector may be populated with values derived from the library-level metrics determined by the Library Analysis Module 123.

The Recommendation Module 125 may be configured to compute similarity scores by comparing a user's characterization vector to a plurality of content vectors, where each content vector represents a candidate media item. Based on these scores, the module may generate and output a ranked list of recommended items. A particular advantage of this approach is its application in improving the operation of a content recommendation engine by solving the “cold-start problem.” Conventional recommendation systems require a history of user consumption data (e.g., purchases, ratings, clicks) to function effectively. For new users or users with no interaction history, these systems cannot provide meaningful recommendations. The present disclosure overcomes this technical problem by generating recommendations based on the intrinsic, structural properties of a user's existing physical library, providing a rich data source for personalization without requiring any user consumption history.

The Compatibility Analysis Module 126 may be configured to determine a compatibility score between two or more entities. It may retrieve a first characterization vector for a first entity and a second characterization vector for a second entity and compute a score based on a comparative structural alignment between the two vectors.

The Social Media Module 127 and the Community Platform Module 128 may represent functionalities that provide a social networking environment. These modules may be configured to allow users to form connections, search the libraries of connected members, or participate in community features such as a marketplace for offering items for sale, barter, or loan, and a digital magazine for posting reviews or articles.

The Retrieval Guidance Module 129 may be configured to assist a user in locating a specific media item. Upon receiving a query, it may identify the item's location from the item dataset and provide guidance, which may comprise visual instructions, such as an image with the item highlighted, or a set of generated verbal or textual instructions.

The database 130 may be configured to store data used and generated by the system 100. Such data may comprise raw or processed image data, item datasets, item-level metrics, library-level metrics, generated characterization vectors for users and libraries, user profiles, and the like. The database 130 may be implemented using any suitable database technology, comprising relational databases (e.g., SQL), non-relational databases (e.g., NoSQL), graph databases, distributed databases, and combinations thereof.

The client device 140 may be any suitable computing device configured for user interaction and data capture. Examples of a client device 140 may comprise a mobile computing device such as a smartphone or tablet, a personal computer, a laptop computer, or a specialized device such as an indoor unmanned aerial vehicle (UAV) or drone equipped with a camera. The client device 140 is shown to comprise a communicator 142, an image capture device 144, and a display 146.

The communicator 142 may be a hardware and/or software component configured to facilitate data exchange with the server system 110 via the network 150. It may utilize any suitable communication protocol, comprising Wi-Fi, cellular (e.g., 4G, 5G), Bluetooth, Ethernet, or the like. The communication may be bidirectional, allowing the client device 140 to transmit image data to the server system 110 and receive results, notifications, and other data in return.

The image capture device 144 may be configured to capture the image data of the physical media library. This may be, for example, a built-in camera on a smartphone, a webcam connected to a computer, or a high-resolution camera mounted on a UAV.

The display 146 may be any suitable screen or monitor configured to present a user interface and output data to a user. Information presented on the display 146 may comprise, for example, a ranked list of recommended items, a compatibility score, suggestions for social connections, or visual guidance for locating a requested media item.

The network 150 facilitates communication between the client device 140 and the server system 110. The network 150 may be any suitable network or combination of networks, such as the Internet, a Local Area Network (LAN), a Wide Area Network (WAN), or a cellular network.

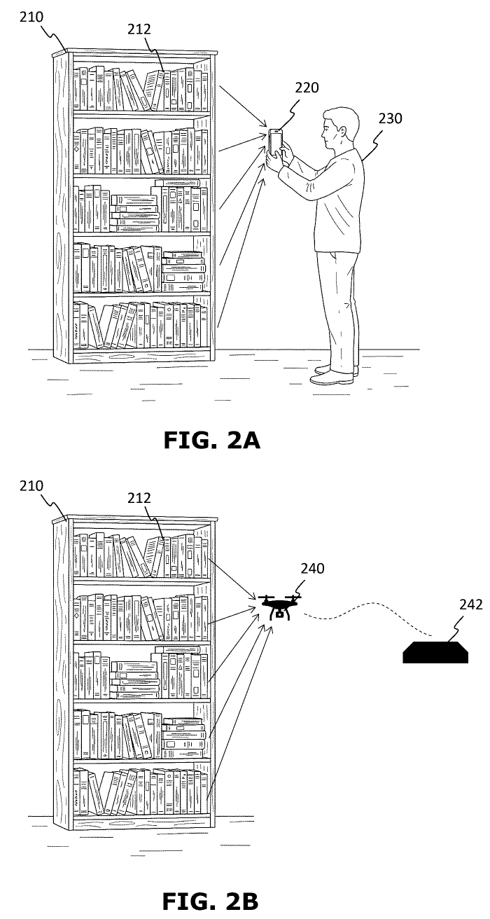

Reference is now made to FIGS. 2A and 2B, which show schematic views of exemplary methods for obtaining image data of a physical media library, in accordance with aspects of the present disclosure. Both figures show a bookshelf 210 containing a plurality of media items 212, which may be books, records, or other forms of physical media.

FIG. 2A shows a user 230 operating a mobile computing device 220 to capture image data of the media items 212 on the bookshelf 210. The mobile computing device 220 may be an example of the client device 140 described in FIG. 1, and may comprise devices such as a smartphone, a tablet computer, a digital camera, or the like. The arrows directed towards the device 220 represent the field of view of its internal image capture device (144), indicating the capture of visual information from the spines of the media items 212. The user 230 may capture one or more images, potentially from varying angles and distances, to ensure comprehensive coverage of the physical library. The captured image data may then be transmitted to the server system 110 for processing.

FIG. 2B shows an alternative method for obtaining image data using an autonomous client device, such as an indoor unmanned aerial vehicle (UAV) 240, also referred to as a drone. This illustrates the integration of the system with autonomous hardware. The UAV 240 may be another example of the client device 140 and may be equipped with an image capture device and a communicator. The UAV 240 is shown performing the specific process of capturing image data of the media items 212 on the bookshelf 210. The dotted line represents an exemplary flight path, which may be autonomously navigated by the UAV 240. The computation of a flight path may be performed by the server system 110 or by an onboard processor to ensure efficient and thorough scanning of one or more bookshelves, for instance, by planning a series of waypoints at optimal distances and angles from the shelves. The scanning operation may be performed periodically or in response to a direct command from a user.

FIG. 2B further shows a docking port 242. The UAV 240 may be configured to autonomously travel to and from the docking port 242 before and after a data capture operation. The docking port 242 may serve multiple functions, comprising, for example, a charging station to replenish the UAV's power source, a wired data communication port to transfer captured image data, a designated landing pad or home base for the UAV, and combinations thereof.

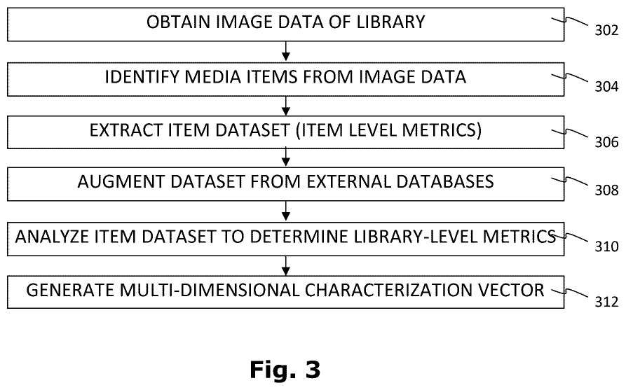

Reference is now made to FIG. 3, which shows a flowchart of a method 300 for generating a characterization vector representing a physical media library, in accordance with aspects of the present disclosure. The method 300 may be performed, for example, by the server system 110 described in FIG. 1.

The method begins with obtaining image data of a physical library (step 302). This step may be performed by a user operating a client device 140, such as by capturing one or more images of a bookshelf 210 with a mobile computing device 220 as shown in FIG. 2A, or by deploying an autonomous device such as a UAV 240 to scan the library as shown in FIG. 2B. The obtained image data may comprise a plurality of images taken from various angles, distances, and under different lighting conditions to ensure comprehensive coverage of the media items. The method may further include performing advanced processing, such as computationally stitching multiple image frames to construct a unified spatial model of a library.

The method continues with identifying a plurality of media items from the obtained image data (step 304). This identification process may be performed by an Image Processing Module 121 and may comprise applying an image analysis technique such as Optical Character Recognition (OCR) to the image data to recognize and extract text from the spines of the media items 212.

The method proceeds by extracting an item dataset comprising a plurality of item-level metrics for each identified media item (step 306). These item-level metrics may be derived directly from the identified text or from further analysis of the image data. The metrics may comprise, for example, a title, an author, a publisher, a year of publication, an edition, a language, a thematic category, a physical location within the library, an assessed physical condition, and combinations thereof. The assessed physical condition may be determined from a pixel-level analysis of the image data, with algorithms configured to identify visual patterns indicative of factors such as dustiness (e.g., by detecting low-contrast haze) or physical wear and deterioration (e.g., by detecting frayed edges or discoloration).

The method may then continue with augmenting the item dataset by querying one or more external databases or online sources (step 308). Using the initially extracted item-level metrics as query terms, the system may retrieve supplementary information to enrich the dataset. Such supplementary information may comprise, without limitation, official genre classifications, publisher details, critical reviews, cover art, related works, and the like. This step may be performed by the Data Extraction Module 122.

The method continues with analyzing the augmented item dataset to determine a plurality of library-level metrics (step 310). This analysis, which may be performed by the Library Analysis Module 123, focuses on the collective, structural, and aggregate properties of the library's contents, and may be performed independently of any data related to user consumption or interaction with the items. The analysis may comprise calculating a frequency of occurrence of shared attributes (e.g., author or genre recurrence), analyzing a temporal distribution of items based on publication or acquisition dates, or assessing the relative popularity of items by comparison to an external reference corpus. The resulting library-level metrics may comprise, for example, author recurrence rates, thematic category distributions, language diversity scores, a ratio of fiction to non-fiction, and the like.

The method concludes by generating a multi-dimensional characterization vector (step 312). This step, which may be performed by the Vector Generation Module 124, involves creating a data structure, such as a vector or an array, and populating it with values derived from the library-level metrics determined in the preceding step. The resulting characterization vector serves as a structured, quantitative profile or signature of the physical media library.

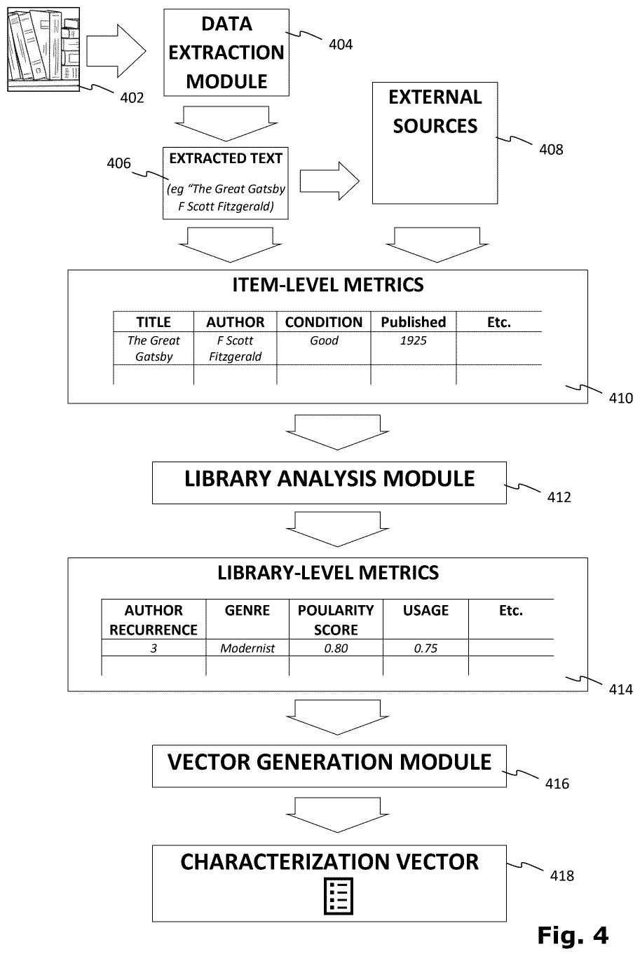

Reference is now made to FIG. 4, which shows a data transformation process diagram 400 illustrating the generation of a characterization vector from raw image data, in accordance with aspects of the present disclosure. The process shows raw image data 402, a Data Extraction Module 404, extracted text 406, external sources 408, a table of item-level metrics 410, a Library Analysis Module 412, a table of library-level metrics 414, a Vector Generation Module 416, and a final characterization vector 418.

The process begins with raw image data 402, which may be a cropped portion of an image showing the spines of one or more media items. This image data 402 may be provided as input to a Data Extraction Module 404, which may be an aspect of the Image Processing Module 121 or the Data Extraction Module 122 shown in FIG. 1. The Data Extraction Module 404 is configured to process the image data to produce extracted text 406. For example, the text “The Great Gatsby, F. Scott Fitzgerald” may be identified and extracted from the spine of a book using Optical Character Recognition (OCR) or similar image-to-text technologies.

The extracted text 406 may then be used to form a query. This query may be sent to one or more external sources 408, which may comprise online booksellers, public library databases, encyclopedic websites (e.g., Wikipedia), or other curated data repositories, to augment the initially identified information.

The information retrieved from the external sources 408, combined with the extracted text 406 and any further analysis of the image data 402 (such as for physical condition), may be used to populate a data structure of item-level metrics 410. As shown, the item-level metrics 410 may be organized in a table and may comprise, for a single media item, a ‘Title’ (e.g., ‘The Great Gatsby’), an ‘Author’ (e.g., ‘F. Scott Fitzgerald’), a ‘Condition’ (e.g., ‘Good’), and a ‘Published’ date (e.g., ‘1925’). Other item-level metrics may comprise, without limitation, publisher, edition, language, genre, page count, physical dimensions, and combinations thereof.

The collection of item-level metrics 410 for all identified media items in the library may then be provided as input to a Library Analysis Module 412. The Library Analysis Module 412 is configured to analyze the aggregate properties of the entire item dataset to determine a set of library-level metrics 414. This analysis may be performed independently of user consumption data. As shown, the library-level metrics 414 may comprise an ‘Author Recurrence’ count (e.g., ‘3’, indicating the author appears three times in the library), a dominant ‘Genre’ (e.g., ‘Modernist’), a calculated ‘Popularity Score’ (e.g., ‘0.80’), and a ‘Usage’ metric (e.g., ‘0.75’, which may be derived from the assessed condition of items). Other library-level metrics may comprise language distribution, publication date histograms, publisher concentrations, and the like.

The determined library-level metrics 414 are subsequently provided to a Vector Generation Module 416. The Vector Generation Module 416 is configured to populate a multi-dimensional data structure, shown as the characterization vector 418, with the values from the library-level metrics. The resulting characterization vector 418 serves as a quantitative and structured signature of the user's physical library. The icon for the characterization vector 418 represents this structured dataset, which may be stored in the database 130 for subsequent use in recommendations, compatibility analysis, or other functions.

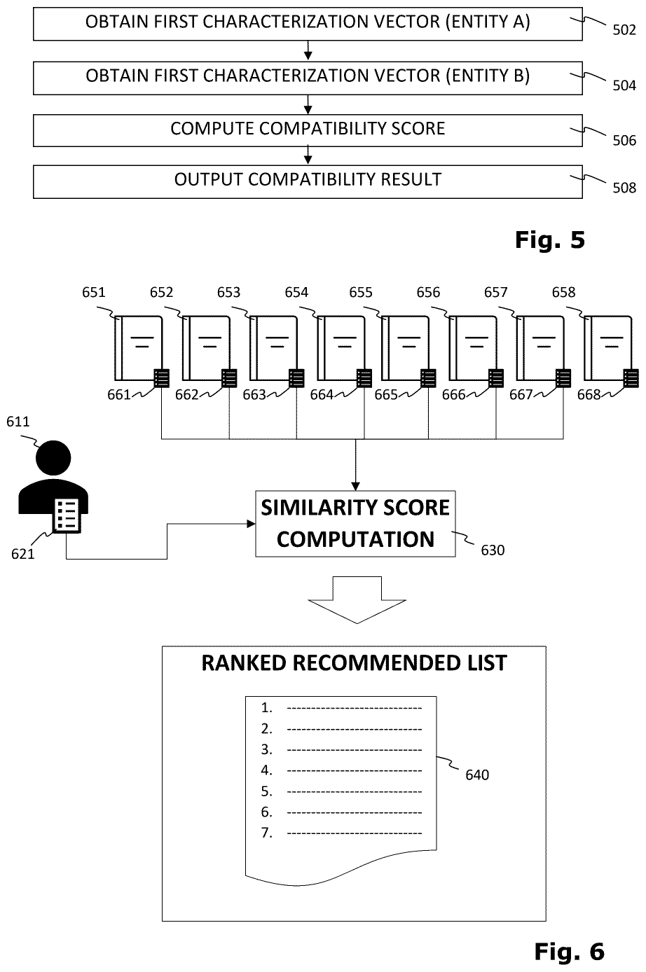

Reference is now made to FIG. 5, which shows a flowchart of a method 500 for determining a compatibility score between two entities, in accordance with aspects of the present disclosure. The method 500 may be performed, for example, by the Compatibility Analysis Module 126 of the server system 110.

The method begins with obtaining a first characterization vector associated with a first entity, referred to as Entity A (step 502). The first entity may be, for example, a first user of the system. The first characterization vector may be a multi-dimensional data structure, such as the vector 418 described in FIG. 4, that represents the library-level metrics of the first entity's media library. This vector may be obtained by retrieving it from a database 130 where it was previously stored, or it may be generated in real-time.

The method continues with obtaining a second characterization vector associated with a second entity, referred to as Entity B (step 504). The second entity may be selected from a group comprising a second user, a group profile representing multiple users, or a curated collection of media items. The second characterization vector may be structurally similar to the first, representing the library-level metrics of the second entity's associated media library.

The method proceeds by computing a compatibility score (step 506). This computation may be based on a comparative structural alignment between the first characterization vector and the second characterization vector. The computation may involve various mathematical algorithms to measure the similarity or alignment between the vectors, comprising, for example, cosine similarity, Euclidean distance, or other vector comparison techniques. In some aspects, the computation may comprise applying an asymmetric weighting to one or more structural dimensions of the first vector relative to the second, allowing for a more nuanced comparison.

The method concludes by outputting a compatibility result (step 508). The primary component of this result may be the compatibility score itself, which may be represented as a numerical value, a percentage, or a qualitative label (e.g., ‘High Match’). The result may be transmitted to a client device 140 for presentation to a user on a display 146. In some aspects, the compatibility result may further comprise at least one explanatory component that identifies the specific structural dimensions or library-level metrics that contributed most significantly to the computed score, providing context for the user. The output may also be used to trigger subsequent actions, such as suggesting a social connection between Entity A and Entity B if the score exceeds a predefined threshold.

Reference is now made to FIG. 6, which shows a conceptual diagram of a content recommendation process 600, in accordance with aspects of the present disclosure. The diagram shows a user icon 611 associated with a library characterization vector 621, a plurality of candidate media items 651-658, each associated with a respective content vector 661-668, a similarity score computation process 630, and a resulting ranked recommended list 640.

The process may begin with a library characterization vector 621, which represents the structural profile of a physical media library associated with a user 611. This vector 621 may be generated according to the methods described in FIG. 3 and FIG. 4. The diagram also shows a plurality of candidate media items 651-658, which may be items that the user does not currently own but may be interested in. Each candidate media item 651-658 is associated with its own respective content vector 661-668. A content vector may be a multi-dimensional data structure similar to the library characterization vector, but representing the intrinsic properties of a single item rather than an entire library.

Both the library characterization vector 621 and the plurality of content vectors 661-668 are provided as input to a similarity score computation process 630. This process may be performed by the Recommendation Module 125 of the server system 110. The computation process 630 is configured to compare the single library characterization vector 621 against each of the individual content vectors 661-668 to determine a similarity score for each candidate media item. The similarity score may quantify the degree of alignment, for example, the structural alignment, between the user's existing library profile and the characteristics of each candidate item.

Based on the computed similarity scores, the process generates a ranked recommended list 640. The candidate media items 651-658 may be sorted in descending order of their similarity scores, with the item having the highest score appearing first on the list. This ranked recommended list 640 may then be outputted to the user 611, for example, by transmitting it to the client device 140 for presentation on the display 146. This provides the user with personalized content recommendations that are based on the intrinsic character of their physical library rather than their past consumption behavior.

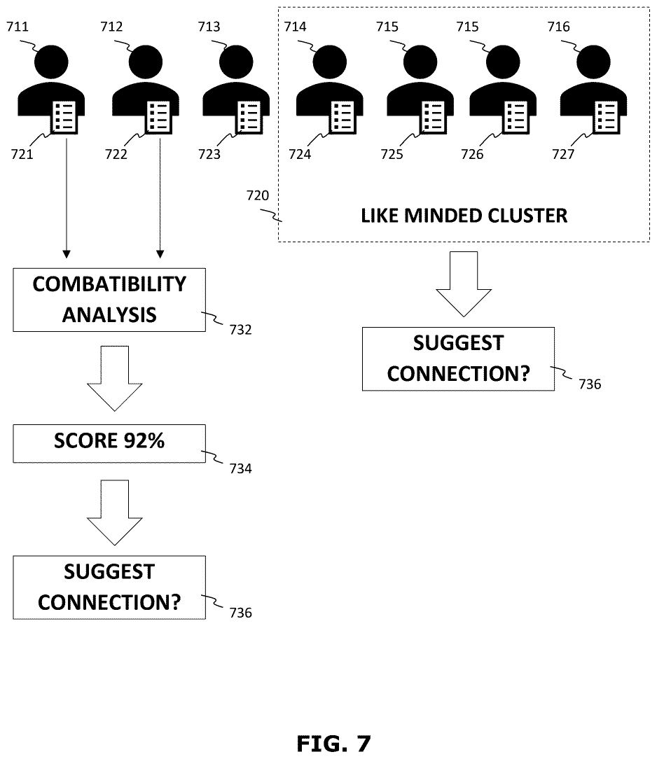

Reference is now made to FIG. 7, which shows a conceptual diagram illustrating social features based on compatibility analysis, in accordance with aspects of the present disclosure. The diagram shows a plurality of user icons 711-716, each associated with a respective characterization vector 721-727. The diagram further illustrates a compatibility analysis process 732, a resulting score 734, a like-minded cluster 720, and a connection suggestion action 736. The figure illustrates at least two related applications of the compatibility analysis functionality.

A first application shown in the diagram is a pairwise compatibility analysis between two individual users. The characterization vector 721 of a first user 711 and the characterization vector 722 of a second user 712 are provided as input to a Compatibility Analysis process 732. This process, which may be performed by the Compatibility Analysis Module 126, computes a compatibility score 734 based on the structural alignment of the two vectors, shown for example as “92%”. If this computed score 734 exceeds a predefined threshold, the system may generate and present a suggestion 736 to one or both users to establish a social connection.

A second application illustrated in the diagram is the identification and use of user groups or clusters. The box labeled “LIKE MINDED CLUSTER” 720 represents a group of users, such as users 714, 715, and 716, who have been identified by the system as having high compatibility with one another based on their respective characterization vectors 724, 725, 726, and 727. This cluster 720 may be formed by the system by performing a plurality of pairwise compatibility analyses among a larger population of users and grouping together those whose mutual compatibility scores are consistently high. Once such a like-minded cluster 720 is identified, the system may leverage this information to facilitate social connections. For example, the system may suggest connections 736 between a user outside the cluster (such as user 711) and one or more individual members of the like-minded cluster 720, thereby helping users discover communities of interest. In this manner, the compatibility analysis may be used both for direct one-to-one user matching and for discovering broader communities within the system.

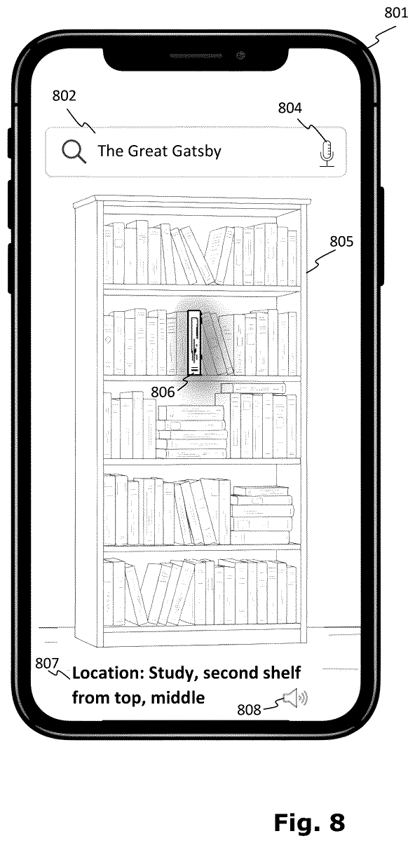

Reference is now made to FIG. 8, which shows an exemplary user interface for a media item retrieval application, in accordance with aspects of the present disclosure. The figure shows a user interface displayed on a client device 801, the interface comprising a search input field 802, a voice input icon 804, a visual representation of a bookshelf 805, a visual highlight 806, a textual location description 807, and an audio output icon 808.

The client device 801 may be an example of the client device 140 shown in FIG. 1, such as a smartphone, tablet, or other suitable computing device. The user interface shown on the display may be part of a dedicated software application configured to interact with the server system 110.

The search input field 802 allows a user to enter a query for a desired media item. The user may enter various search criteria, comprising a title, an author, a keyword, a phrase from the item, or the like. As shown, the user has entered the query “The Great Gatsby.” The interface may also comprise a voice input icon 804, indicating that the user may alternatively speak their query as a voice command.

In response to the user's query, the system may present guidance information on the display. This may comprise a visual representation of a bookshelf 805, which may be an image previously captured by the user or a digitally rendered model of the user's physical library. The system may identify the specific location of the requested media item and indicate it with a visual highlight 806. The visual highlight 806 may be a graphical overlay, such as a glowing outline, a pointing arrow, a change in color or brightness, or other suitable indicator that unambiguously draws the user's attention to the correct item on the shelf.

In addition to visual guidance, the interface may provide a textual location description 807. This description may provide clear, human-readable instructions to help the user find the item, for example, “Location: Study, second shelf from top, middle.” The interface may further comprise an audio output icon 808, indicating that the system may also provide the location instructions as a set of generated verbal instructions. In combination, these multi-modal guidance features (visual, textual, and audio) may be presented to a user to facilitate the efficient location and retrieval of a physical media item from their library. This functionality may be provided by the Retrieval Guidance Module 129.

The terms ‘comprises’, ‘comprising’, ‘includes’, ‘including’, ‘having’ and their conjugates mean ‘including but not limited to’. Such terms encompass the terms ‘consisting of’ and ‘consisting essentially of’.

Whenever a numerical range is indicated herein, it is meant to include any cited numeral (fractional or integral) within the indicated range. The phrases ‘ranging between’ a first indicated number and a second indicated number and ‘ranging from’ a first indicated number ‘to’ a second indicated number are used herein interchangeably and are meant to include the first and second indicated numbers and all the fractional and integral numerals therebetween. Accordingly, the description of a range should be considered to have specifically disclosed all the possible sub-ranges as well as individual numerical values within that range.

As used herein the term ‘about’ refers to at least ±10 %.

What is claimed is:

1. A computer-implemented method for generating a characterization vector representing a physical media library, the method comprising:
obtaining image data of the physical media library;
identifying a plurality of media items from the image data;
extracting an item dataset from the image data, the item dataset comprising a plurality of item-level metrics pertaining to each identified media item;
analyzing the item dataset to determine a plurality of library-level metrics, wherein the library-level metrics are derived from collective attributes of the media items and are independent of behavioral data indicating user consumption of said items; and
generating the characterization vector as a multi-dimensional data structure populated with values derived from the determined plurality of library-level metrics.

2. The method of claim 1, wherein obtaining the image data comprises capturing one or more images of bookshelves within the physical media library using a camera of a mobile computing device.

3. The method of claim 1, wherein obtaining the image data comprises capturing one or more images of bookshelves within the physical media library using a camera mounted on an indoor unmanned aerial vehicle (UAV).

4. The method of claim 1, wherein identifying the plurality of media items comprises performing optical character recognition (OCR) on text displayed on the spines of the media items in the image data.

5. The method of claim 1, wherein extracting the item dataset further comprises augmenting data identified from the image data by querying one or more external databases to retrieve supplementary information.

6. The method of claim 1, wherein the item-level metrics are selected from a group consisting of: a title, an author, a publisher, a year of publication, an edition, a language, a thematic category, a physical location within the library, and an assessed physical condition.

7. The method of claim 1, wherein analyzing the item dataset to determine the plurality of library-level metrics comprises performing at least one of: calculating a frequency of occurrence of a shared attribute among the plurality of media items; analyzing a temporal distribution associated with the plurality of media items; or assessing a relative popularity of one or more of the media items by comparison to an external reference corpus.

8. The method of claim 1, further comprising assigning a reliability weight to each media item in the item dataset, wherein the analysis in the analyzing step is performed on a weighted item dataset.

9. The method of claim 1, further comprising: computing a plurality of similarity scores by comparing the generated characterization vector to a plurality of content vectors, each content vector being associated with a candidate media item; and outputting a ranked list of recommended candidate media items based on the plurality of similarity scores.

10. A system for generating a characterization vector representing a physical media library, the system comprising:
(a) a client device comprising an image capture device and a communication interface, the client device configured to:
(i) capture image data of the physical media library; and
(ii) transmit the image data via the communication interface; and
(b) a server system communicatively coupled to the client device, the server system comprising one or more processors and a database, wherein the one or more processors are configured to execute instructions for a plurality of modules comprising:
(i) an Image Processing Module configured to receive the image data from the client device and identify a plurality of media items from the image data by performing optical character recognition (OCR) on text displayed on the spines of the media items;
(ii) a Data Extraction Module configured to extract an item dataset by retrieving item-level metrics for each identified media item, wherein retrieving the item-level metrics comprises querying one or more external databases;
(iii) a Library Analysis Module configured to analyze the item dataset to determine a plurality of library-level metrics derived from collective attributes of the media items, the analysis being independent of user consumption data; and
(iv) a Vector Generation Module configured to generate the characterization vector as a multi-dimensional data structure populated with values derived from the determined library-level metrics and store the characterization vector in the database.

11. The system of claim 10, wherein the client device is a mobile computing device.

12. The system of claim 10, wherein the client device is an indoor unmanned aerial vehicle (UAV).

13. The system of claim 10, wherein the Image Processing Module is further configured to construct a unified spatial model of the physical media library by computationally stitching a plurality of image data frames, wherein said stitching corrects for variations in perspective and lighting.

14. The system of claim 10, wherein the one or more processors are further configured to execute instructions for a Compatibility Analysis Module configured to:
receive a first characterization vector associated with a first user and a second characterization vector associated with a second entity; and compute a multi-dimensional compatibility score based on a comparative structural alignment between the first and second characterization vectors.

15. The system of claim 10, wherein the one or more processors are further configured to execute instructions for a Recommendation Module configured to: compute a plurality of similarity scores by comparing the generated characterization vector to a plurality of content vectors associated with candidate media items; and output a ranked list of recommended candidate media items based on the similarity scores.

16. The system of claim 10, wherein the one or more processors are configured to execute instructions for a Retrieval Guidance Module configured to: receive a user query for a specific media item; identify the location of the specific media item from the item dataset; and provide location instructions to the user.

17. The system of claim 10, wherein the one or more processors are configured to execute instructions for a Community Platform Module configured to provide at least one of: a marketplace for users to offer media items for sale, barter, or loan; a social network enabling users to search the media libraries of connected members; or a digital magazine for posting and sharing reviews and articles.

18. A computer-implemented method for determining a compatibility score between a first entity and a second entity based on their respective media libraries, the method comprising:
(a) obtaining a first characterization vector associated with the first entity, wherein the first characterization vector is a multi-dimensional data structure representing library-level metrics of a first media library, the library-level metrics being derived from collective attributes of media items within the first media library and being independent of user consumption data;
(b) obtaining a second characterization vector associated with the second entity, the second characterization vector representing library-level metrics of a second media library;
(c) computing, by one or more processors, the compatibility score based on a comparative structural alignment between the first characterization vector and the second characterization vector; and
(d) outputting a compatibility result comprising the compatibility score for presentation to a user.

19. The method of claim 18, wherein the first entity is a first user and the second entity is selected from a group consisting of: a second user, a group profile, and a curated collection.

20. The method of claim 18, further comprising clustering a plurality of users into one or more groups based on compatibility scores computed between the respective characterization vectors of the plurality of users.
